(19) United States
(12) Patent Application Publication
(10) Pub. No.: US 2005/0279168 A1
(43) Pub. Date: Dec. 22, 2005

(54) Test stand and method for measuring sound insulation or insertion loss on a test object

(75) Inventor: Ralph Bungenberg, Düsseldorf (DE)

Correspondence Address: WILLIAM COLLARD;COLLARD & ROE, P.C., 1077 NORTHERN BOULEVARD, ROSLYN, NY, 11576, US

(73) Assignee: CARCOUSTICS TECH CENTER GMBH

(21) Appl. No.: 11/158,033

(22) Filed: Jun. 21, 2005

(30) Foreign Application Priority Data
Jun. 21, 2004 (DE) 10 2004 029 714.2

(51) Int. Cl. G01N 29/04

(52) U.S. Cl. 73/571

(57) ABSTRACT

The invention relates to a test stand and a method for measuring sound insulation or insertion loss on a test object. The test stand includes a transmitting chamber (1) provided with a plurality of sound transmitters (6) and an adjacent receiving chamber (2), which is separated from the transmitting chamber by a dividing wall (3) or dividing floor with a test aperture for arranging the test object (4). The transmitting chamber is provided with a sound transmitter array (5), which includes at least four sound transmitters (6), that are arranged in a plane that extends essentially parallel to the dividing wall (3) or dividing floor. A controlling means is assigned to the sound transmitters (6), and the sound transmitters are controlled thereby so as to create optionally either a diffuse sound field or an essentially unidimensional sound field directed towards the test object (4). For measurement with a unidimensional sound field, the sound transmitters (6) can be controlled so that the sound is incident either perpendicularly or at a specified angle other than perpendicularly on the test object (4). In this context, the controlling means is preferably configured such that the angle of incidence of the unidimensional sound field on the test object (4) is adjustable to any value.

The invention relates to a test stand and a method for measuring sound insulation or insertion loss on a test object.

In order to measure sound insulation in large assemblies and material installations, both window and ceiling test stands are used. These test stands generally include a transmitting chamber equipped with sound transmitters, and a receiving chamber equipped with one or more microphones, a test aperture being formed between the transmitting chamber and the receiving chamber to accommodate the object being tested. Window test stands are used to measure the sound insulation of relatively large, vertically disposed components and material installations such as car body dash board coverings, while horizontal components, such as vehicle floor installations are tested in corresponding ceiling test stands. The sound transmitters and spatial geometries of conventional window and ceiling test stands are such as to create a diffuse sound field.

A classic measurement device for determining frequency-dependent sound insulation of material samples is the “double” impedance measuring tube (Kundt's tube). With this instrument, it is possible to obtain readings of relatively high accuracy, while measurements can be made with relatively small material samples. However, in this measurement procedure a unidimensional wave field is produced, i.e. the sound is directed perpendicularly at the material sample, which is often not consistent with the actual acoustic conditions at location where the component in question is installed. Measurement with a “double” impedance measurement tube essentially corresponds to a measurement of direct sound under free field conditions. Unlike sound propagation outside, sound propagation in enclosed spaces causes reflection phenomena at the limits of the space. It is true that in an enclosed space the influence of unidimensional direct sound usually predominates close to a source of sound, but a more diffuse sound field is created farther from the source of sound as a result of the reflection phenomena.

Accordingly, different test stands are required depending on the sound field in which the sound insulation of a test object is to be measured. The difficulty in this context is that measuring the same test object in different test stands generally yields different measurement results for the sound insulation under investigation.

The object underlying the present invention is to provide a test stand and a method with which the sound insulation measurement or the insertion loss (transmission loss) in components, materials or material installations may be determined under varying acoustic sound fields with relatively little effort.

This object is solved with a test stand having the features of claim 1 and a method having the features of claim 13.

The test stand according to the invention includes a transmitting chamber provided with a plurality of sound transmitters and an adjacent receiving chamber, which is separated from the transmitting chamber by a dividing wall or dividing floor, with a test aperture in which the test object is disposed. The transmitter chamber is provided with a sound transmitter array that includes at least four sound transmitters, which are arranged in a plane that extends essentially parallel to the dividing wall or dividing floor. A controlling means is allocated to the sound transmitters, via which the sound transmitters are controllable so as to produce optionally either a diffuse sound field or an essentially unidimensional sound field that is directed towards the window-like test aperture in the dividing wall or dividing floor. At least one microphone is arranged in the receiving chamber to record the sound that the test body allows to pass through.

In this way, the invention enables measurement of sound insulation or insertion loss (transmission loss) at various test objects with varying sound fields in a single test stand. The test stand according to the invention thus replaces or represents a combination of several test stands, e.g. a window test stand and a double impedance measurement tube (TL tube). As a result, the effort that was previously required for example to set up the various test stands for generating specific sound fields, may be reduced.

An advantageous embodiment of the invention consists in that the sound transmitters are controllable via the controller so that they produce an essentially unidimensional sound field, which is directed towards the window-like test opening optionally perpendicularly or at an angle of incidence other than the perpendicular. In such a case, the controller is preferably designed so that the angle of incidence of the essentially unidimensional sound field on the test object may be altered at will. The test stand according to the invention then offers the additional option to take measurements with a freely defined angle of incidence of sound on the test object. In other words, the invention provides a single test stand for generating any sound field conditions that may be of interest (perpendicular sound incidence, diffuse sound field or any directed sound angle of incidence (+90° to −90°)).

The controlling means that is allocated to the sound transmitters may particularly be a multichannel computer controlling means.

With regard to the generation of a unidimensional sound field, the inside of the transmitting chamber should be furnished with a sound absorbing or low-reflection lining. In this way, the creation of diffuse sound field components caused by reflection may be suppressed.

A further advantageous embodiment of the test stand according to the invention is characterized in that the transmitting chamber and the receiving chamber are coupled and are spatially modifiable mounted, so that the test opening may be positioned vertically or horizontally, or at any inclined angle, at will. With this design, the test stand according to the invention combines a window-type and ceiling type test stand or test stands, in which the sample for testing must be arranged in a specific orientation, or in which the force of gravity must act on the test specimen from a specific angle.

Further preferred and advantageous embodiments of the test stand according to the invention and the method according to the invention are described in the subordinate claims.

In the following, the invention will be explained in greater detail with reference to a drawing showing an embodiment of the invention. In the drawing:

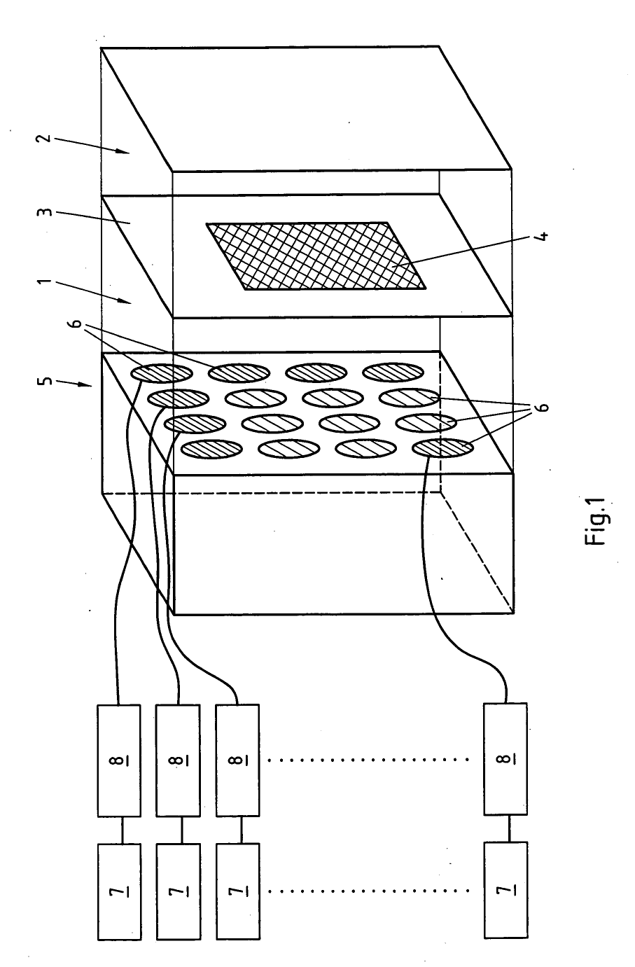

FIG. 1 is a schematic representation of a test stand according to the invention in perspective view;

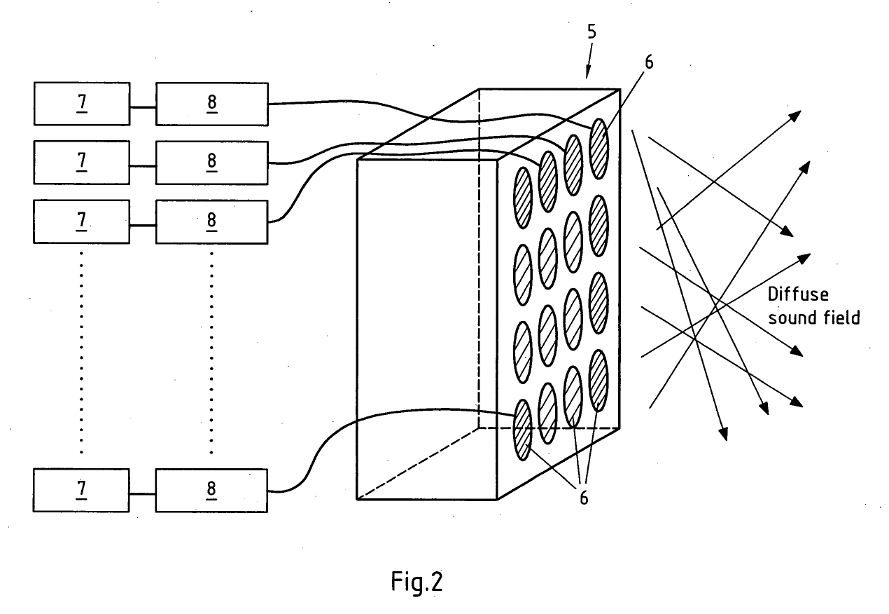

FIG. 2 is a schematic representation of a part of the test stand of FIG. 1 in a control mode that produces a diffuse sound field;

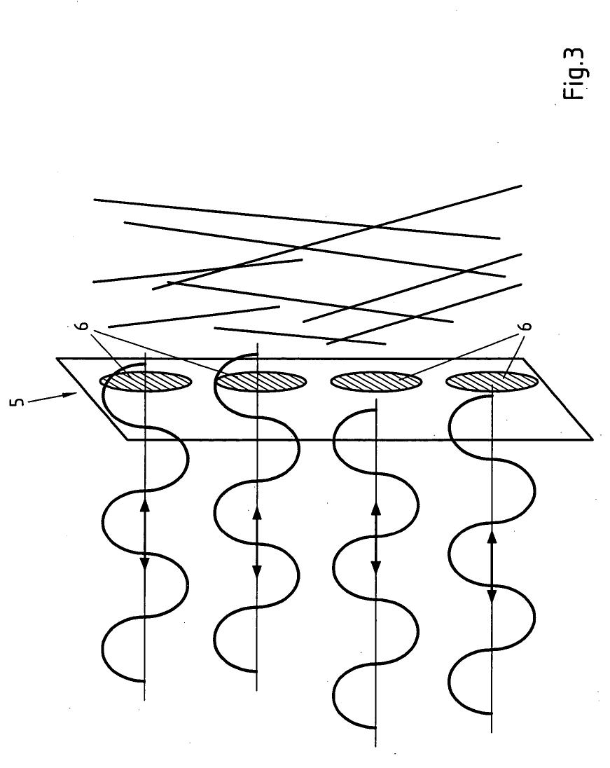

FIG. 3 is a schematic representation for further illustration of a control mode that produces a diffuse sound field;

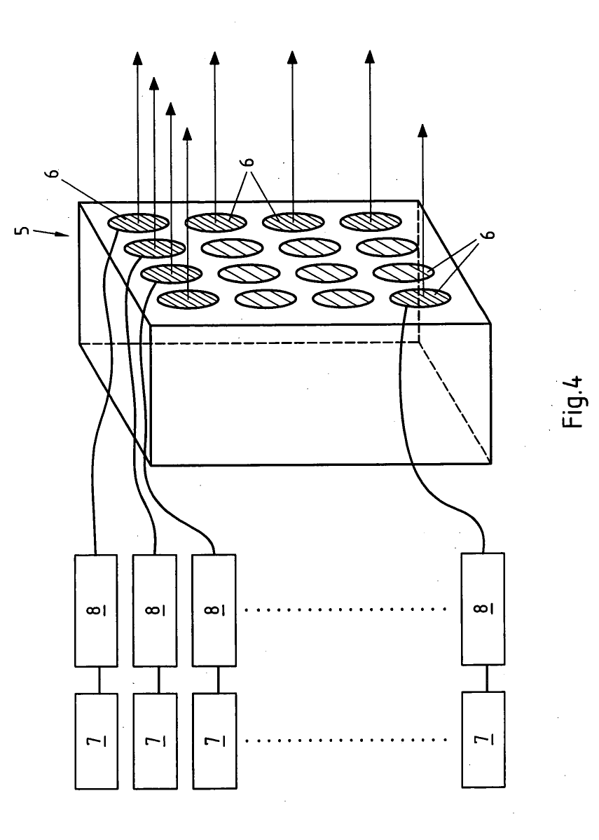

FIG. 4 is a schematic representation of a part of the test stand of FIG. 1 in a control mode that produces a unidimensional sound field with perpendicular incidence of sound on the test object;

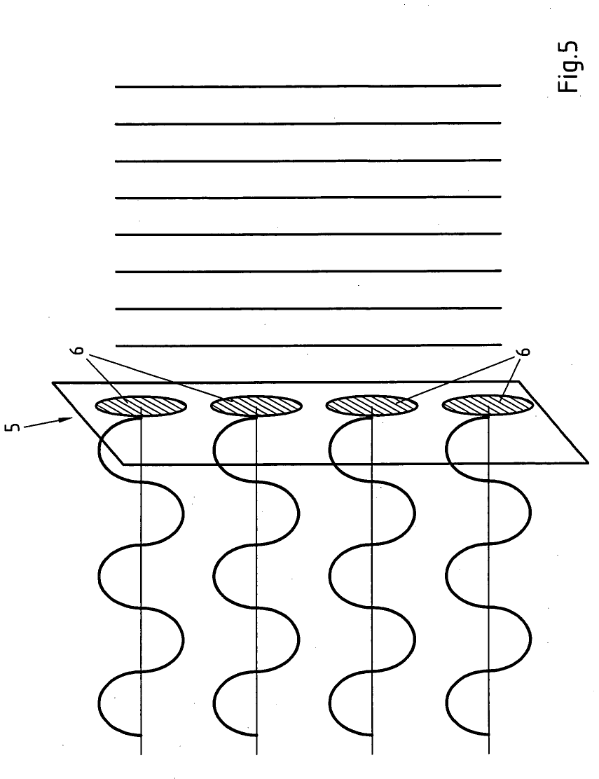

FIG. 5 is a schematic representation for further illustration of the control mode for producing a planar wave front with a perpendicular incidence of sound on the test object;

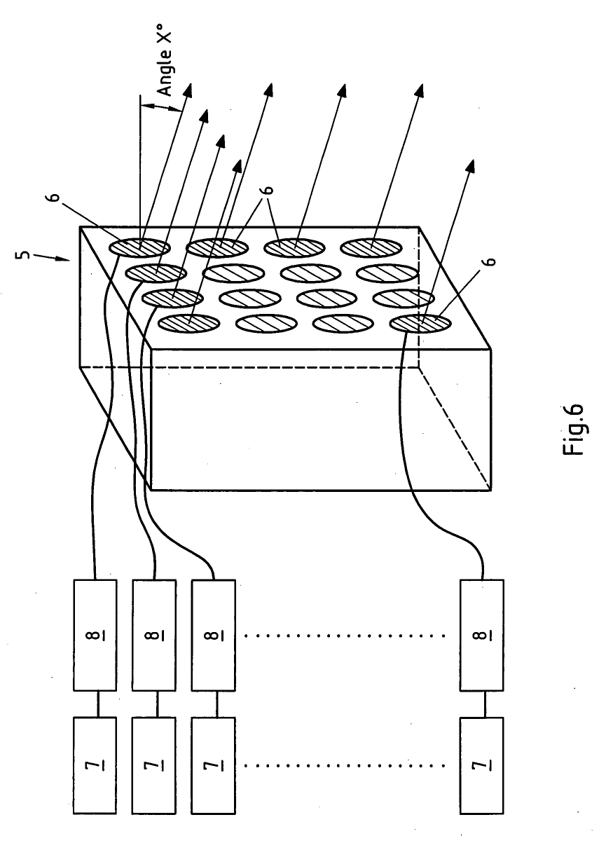

FIG. 6 is a schematic representation of a part of the test stand of FIG. 1 in a control mode that produces a unidimensional sound field with a specified angle of incidence of sound on the test object that is not perpendicular;

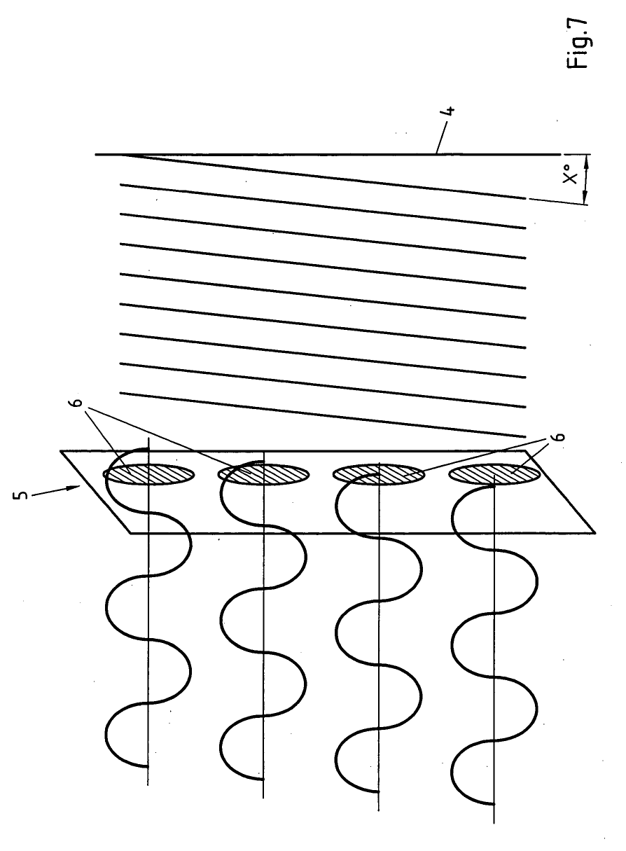

FIG. 7 is a schematic representation for further illustration of the control mode for producing a planar wave front with a defined angle of incidence of sound on the test object that is not perpendicular; and

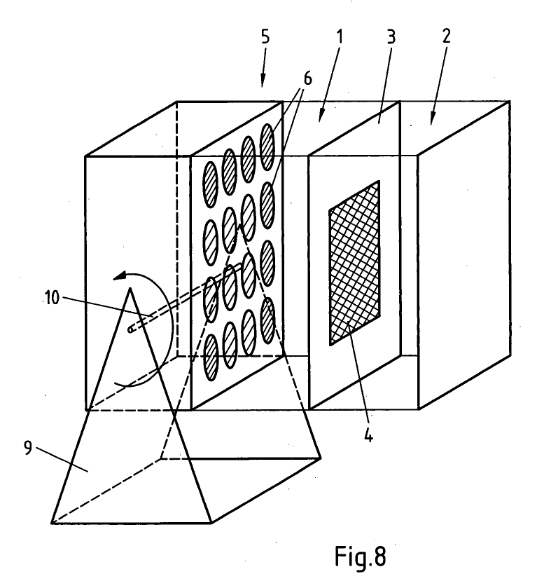

FIG. 8 is a schematic representation of an embodiment of the test stand according to the invention, in which the test stand is supported so as to be spatially movable (swivelling).

The test stand shown schematically in FIG. 1 includes a transmitting chamber 1 and a receiving chamber 2 directly adjacent thereto, which is separated from the transmitting chamber by a dividing wall 3, which has a test aperture to accommodate a test object 4.

Transmitting chamber 1 and receiving chamber 2 are coupled and supported on a structure or frame (not shown) such that they are spatially variable, in particular so that the test aperture with test object 4 may be arranged optionally vertically or horizontally. The test stand according to the invention thus represents a combination of a window and a ceiling test stand. The spatially variable support of the test stand is designed so that the test aperture and accordingly test object 4 may be disposed in any plane between the vertical and the horizontal (+/−360°).

Test object 4 may be a material sample, a material installation including one or more layers, a structural part or a complete component, e.g. a vehicle dash board covering. Dividing wall 3 may be constructed in multiple segments, allowing the size of the test aperture to be adapted to the size of test object 4.

The inside of transmitting chamber 1 is furnished with a sound absorbing lining. Transmitting chamber 1 is preferably designed with low reflectivity. To this end, the walls, ceiling and floor of transmitting chamber 1 are furnished with a highly absorbent lining, which may be constructed for example from wedge-shaped elements made from open-pored foam or other absorbent material and pointing into the chamber.

Transmitting chamber 1 is equipped with a sound transmitter array 5 that includes at least four equal, preferably at least sixteen equal sound transmitters 6. The number of sound transmitters is preferably equal to a square number (4, 9, 16, 25, . . . ). Sound transmitters 6 are arranged on one plane and equidistantly from each other in a square grid. If desired, sound transmitters 6 may also be arranged in a circular or stochastic pattern instead of a grid. In the case of the circular arrangement sound transmitters 6 are preferably arranged in concentric circles. Sound transmitters 6 may be implemented as wideband loudspeakers. In particular, they may be loudspeakers that have a planar oscillation membrane. Besides wideband loudspeakers, high-pitch loudspeakers may also be used for high-frequency investigations. In particular, the loudspeaker panel may be designed to be replaceable for this purpose, i.e. for high-frequency investigations a panel with wideband loudspeakers may be removed and replaced by a panel with high-pitch loudspeakers, which are generally smaller than wideband loudspeakers.

Planar transmitter array 5 and accordingly the shared plane of sound transmitters 6 is parallel to dividing wall 3. Transmitter array 5 and/or dividing wall 3, which extends essentially parallel thereto, are movable, so that the distance between sound transmitter array 5 and dividing wall 3 is adjustable.

Each sound transmitter 6 has its own tone generator 7 and its own power amplifier 8. Sound transmitters 6 may thus be controlled individually in targeted manner. For the sake of clarity, only a few of the tone generators 7 and output amplifiers 8 are shown in the drawing.

A controlling means is allocated to tone generators 7, via which they, and accordingly sound transmitters 6 may be controlled individually, so as to create optionally either a diffuse sound field or an essentially unidimensional sound field directed towards the window-like aperture in dividing wall 3 in which test object 4 is located. The controlling means that is allocated to tone generators 7 and sound transmitters 6 may for example be a multi-channel computer controlling means.

FIGS. 2 and 3 show a control mode that produces a diffuse sound field in transmitting chamber 1. Here, generators 7 are all controlled with time shift phase position. Accordingly, a diffuse wave front is produced.

The diffuse incidence of sound on the test object (test sample) includes angles of incidence in the range from −90° to +90° relative to a perpendicular angle of incidence having an angle of 0°. This control mode corresponds to the measurement conditions in a conventional window or ceiling test stand.

As is shown in FIGS. 4 and 5, the test stand according to the invention may also be operated in a control mode that corresponds to free field conditions with perpendicular angle of incidence of sound on the test object. In this mode, generators 7 are all actuated with the same phase position. Alternatively, all output amplifiers 8 may also be actuated at the same time with a single generator. In each case, an essentially planar wave front is produced, i.e. a unidimensional sound field with perpendicular angle of incidence of sound on test object 4 (see FIG. 1).

Additionally, the test stand according to the invention may also be operated in a control mode that produces an essentially unidimensional sound field which is directed towards test object 4 with an angle of incidence X° that is not perpendicular. As is shown schematically in FIGS. 6 and 7, for this purpose all generators 7 are actuated with constant phase position which is however offset relative to each other in groups. For this purpose, generators 7 are organised in groups, each group being assigned to either a row or a column of the grid arrangement of transmitter array 5.

FIG. 7 shows that the phase shift angle between the actuating signal for one row or column of sound transmitters 6 relative to the actuating signal for the next row or column of sound transmitters 6 is set to the same value in all cases. Accordingly, an essentially planar wave front is produced with an angle of sound incidence X° at test object 4 that corresponds to the phase shift angle set.

The phase shift angle may be set to any value with the control device according to the invention, so that an essentially unidimensional sound field is produced that is incident on test object 4 at a definite angle.

At least one microphone (not shown) is arranged in receiving chamber 2 of the test stand to record the sound that test object 4 allows to pass through (see FIG. 1). However, preferably a microphone array (not shown) including multiple microphones is arranged in receiving chamber 2. In this case, the microphones are arranged in a plane extending parallel to the plane of dividing wall 3 and equidistant from each other in a square grid pattern. With a microphone array of such kind it is possible to locate local partial sound sources on radiating structural surfaces. In particular, such a microphone array enables the sound pressure or sound volume distribution to be determined over the whole of test object 4. In this way, information may be obtained about the radiation characteristics and mode distribution with respect to test object 4. In addition, the sound volume in the receiving chamber may also be measured with a rotating microphone situated in the receiving chamber.

FIG. 8 is a schematic representation of an embodiment in which the test stand according to the invention is mounted so as to be able to swivel. The swivel range is 360°. The reference number 9 demotes a holding device or rack which receives the test stand in a slewable manner. The axis of rotation is denoted by reference number 10. Such an embodiment allows measurements of sound insulation or insertion loss (transmission loss) to be taken in which gravity acts on test object 4 at a freely definable angle.

The design of the invention is not limited to that of the embodiment described in the aforegoing. On the contrary, many variants are possible, which remain based on the inventive idea reflected in the claims even while differing fundamentally in design. For example, sound transmitter array 5 may also include fewer or more than 16 equal sound transmitters, e.g. a sound transmitter array 5 including 12, 20 or 100 loudspeakers that are actuatable individually or in groups may be used. Besides the square and grid-like arrangement of sound transmitters 6, the scope of the invention also provides for a circular or stochastic arrangement of sound transmitters for producing special sound fields, for example to generate a spherical wave front. Moreover, transmitting chamber 1 may also be arranged above or below receiving chamber 2 to replicate a ceiling test stand.

1. A test stand for measuring sound insulation or insertion loss of a test object (4), including a transmitting chamber (1), in which a plurality of sound transmitters (6) are arranged, and a receiving chamber (2), which is separated from the transmitting chamber by a dividing wall (3) or dividing floor, with a test aperture for disposing the test object (4), wherein at least one microphone is arranged in the receiving chamber (2), wherein
the transmitting chamber (1) is provided with a sound transmitter array (5), including at least four sound transmitters (6), which are arranged in a plane essentially parallel to the dividing wall (3) or dividing floor, wherein a controlling means is allocated to the sound transmitters (6), via which the sound transmitters (6) are controllable such that optionally either a diffuse sound field or an essentially unidimensional sound field is created that is directed towards the test aperture.

2. The test stand according to claim 1, wherein
the sound transmitters (6) can be controlled by the controlling means such that an essentially unidimensional sound field is created, which is directed towards the test opening optionally perpendicularly or at an angle of incidence (X°) other than perpendicular.

3. The test stand according to claim 1, wherein
the angle of incidence (X°) of the essentially unidimensional sound field on the test object can be changed via the controlling means.

4. The test stand according to claim 1, wherein
the sound transmitter array (5) includes at least 16 sound transmitters (6).

5. The test stand according to claim 1, wherein
the sound transmitters (6) are arranged in a uniform grid, in a circle, or stochastically.

6. The test stand according to claim 1, wherein
the sound transmitters (6) are wideband loudspeakers and/or high-pitch loudspeakers.

7. The test stand according to claim 1, wherein
the sound transmitters (6) are mounted in a replaceable panel.

8. The test stand according to claim 1, comprising
multiple interchangeable sound transmitter panels, including at least one panel provided with wideband loudspeakers and one panel provided with high-pitch loudspeakers.

9. The test stand according to claim 1, wherein
a dedicated tone generator (7) and/or a dedicated output amplifier (8) is allocated to each sound transmitter (6).

10. The test stand according to claim 1, wherein
the controlling means consists of a multi-channel computer controlling means.

11. The test stand according to claim 1, wherein
the inside of the transmitting chamber (1) is furnished with a sound absorbing lining.

12. The test stand according to claim 1, wherein
a microphone array including multiple microphones or a rotating microphone is arranged in the receiving chamber (2).

13. The test stand according to claim 1, wherein
the sound transmitter array (5) and/or the dividing wall/floor extending parallel thereto are movable, so that the distance between sound transmitter array (5) and dividing wall (3) or between sound transmitter array and dividing floor is adjustable.

14. The test stand according to claim 1, wherein
the volume of the transmitting chamber (1) is adjustable.

15. The test stand according to claim 1, wherein
the transmitting chamber (1) and the receiving chamber (2) are coupled with each other and are mounted in such a manner that they can be spatially altered, with the result that the test opening is optionally positionable vertically, horizontally, or at any inclined angle.

16. A method for measuring the sound insulation and insertion loss of a test object (4), in which a test stand is used including a transmitting chamber (1) with multiple sound transmitters (6) and a receiving chamber (2) with at least one microphone, wherein the transmitting chamber (1) and the receiving chamber (2) are separated by a dividing wall (3) or dividing floor with a window-like aperture for arranging the test object (4), wherein
a transmitter array (5) including at least four sound transmitters (6) is arranged in the transmitting chamber (1) in such manner that sound transmitters (6) are disposed in a plane that is essentially parallel to the dividing wall (3) or dividing floor, and that the sound transmitters (6) are controlled by a controlling means such that either a diffuse sound field or an essentially unidimensional sound field directed at the test object (4) is created.

17. The method according to claim 16, wherein
the sound transmitters (6) are controlled via the controlling means in such manner that an essentially unidimensional sound field is created, that is directed optionally perpendicularly to or at an angle of incidence (X°) other than perpendicular to the test object (4).

18. The method according to claim 16, wherein
the angle of incidence (X°) of the essentially unidimensional sound field on the test object (4) is changed via the controlling means.

19. The method according to claim 16, wherein
the sound transmitters (6) are arranged in a uniform grid or in a circle.
